(19) United States
(12) Patent Application Publication
(10) Pub. No.: US 2007/0286297 A1
(43) Pub. Date: Dec. 13, 2007

(54) Method for co-channel interference suppression in orthogonal frequency division multiplexing (OFDM) systems with multiple receiving antennas

(75) Inventors: Kwang-Cheng Chen, Taipei City (TW); Ching-Sheng Ni, Changhua County (TW); Heng-Iang Hsu, Taipei City (TW); Wu-Chi Wang, Hsinchu City (TW); Chih-Chiang Hsieh, Kaohsiung County (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/448,798

(22) Filed: Jun. 8, 2006

(51) Int. Cl. H04K 1/10

(52) U.S. Cl. 375/260

(57) ABSTRACT

A method for co-channel interference suppression in Orthogonal Frequency Division Multiplexing (OFDM) systems with multiple receiving antennas is provided, wherein the co-channel interference (CCI) in different directions is suppressed by the spatial technique provided by the antenna arrays, and the interference to a desired carrier caused by other sub-carriers is also taken into consideration, that is, the interference of other sub-carriers is cancelled by means of a multistage interference cancellation, thereby the performance for interference suppression is improved.

### BACKGROUND OF THE INVENTION

1. Field of Invention

The present invention relates to a method for co-channel interference suppression in Orthogonal Frequency Division Multiplexing (OFDM) systems with multiple receiving antennas, to solve the co-channel interference in OFDM systems.

2. Related Art

A main challenge in designing a wireless communication system lies in maximizing the system capacity and raising the anti-multipath effect and the anti-interference ability thereof The system capacity refers to the number of users the system can provide service for. The multipath phenomenon is generated because the transmitted radio electromagnetic wave is reflected by a barrier when being propagated in an open space, such that the receiving end may receive signals from different directions and paths. As the signal strength may fade when propagating in the propagation channel, generally speaking, the signal strength may fade more dramatically or generate a phase shift after being reflected by the barrier, and so-called multipath fading is generated. The interference phenomenon is generated because the signal to be received by the receiving end is interfered with by other signals, wherein the interference may be caused by many factors; most are caused unintentionally and the interference source is at the outside of the sending end, i.e. beside the direct control of the sending end. However, the multipath fading effect and interference are main factors limiting the system capacity.

In the multipath propagation channel, the transmitted signal is propagated to the receiving end via multiple paths. As each path has a property of time delay and complicated gain, the received signal is formed by a superposition of different duplicates generated by the transmitted signal after being delayed, faded, and phase shifted. The duplicates of multiple transmitted signals may cause an additive or destructive interference to the existing signals in the used band, and such interference may cause an undesired strength variance to the signals to be received. Therefore, the multipath phenomenon may cause a serious distortion of the received signal. Moreover, different propagation paths have different delay times τₘₐₓ. When the delay time is larger than the symbol duration T of the information symbol, an inter-symbol interference (ISI) may be caused. As for the ISI, an information symbol sent previously and an information symbol sent latterly are received by the receiving end at a same time due to the time delay, destroying the signal structure. Therefore, the ISI degree is indicated by a τₘₐₓ/T ratio, wherein when T is decreased, and the data transmission rate is increased, then the τₘₐₓ/T ratio is increased, and the ISI is worsened. When the τₘₐₓ/T ratio is too large, it will be very difficult to modify the multipath effect in the receiving end.

Besides the multipath effect, interference is another important factor limiting the system efficiency. If the system is operated in an unlicensed band, the system will be interfered with if other users use the band. In the cellular system, the frequency resource is improved through a frequency reuse technique, wherein a large a geographic area is divided into many small areas which are called cells. Typically, a cell is allocated with a base station, and each base station operates in an assigned frequency. The term ‘frequency reuse’ refers to assigning a limited number of frequencies to the base stations, wherein adjacent base stations use different frequencies. If the adjacent base stations use a same frequency, interference will be easily caused, which is called co-channel interference (CCI), and the channel refers to the frequency. However, nonadjacent base stations using a same frequency may cover each other because of an over large transmitting power, therefore a CCI may also be caused.

A frequency reuse factor is defined by an interrelation between the shortest distance between two cells using the same frequency and the radii of the cells. Usually, a larger frequency reuse factor indicates a weaker frequency utilization rate, and a good frequency utilization rate is defined as that the frequencies of adjacent cells will be overlapped in a system using only a small number of frequencies. To efficiently use the precious frequency resource and raise the frequency utilization rate, CCI should be suppressed.

The ISI generated by the multipath effect can be solved by using the OFDM technique, which is a multi-carrier transmission technique and mainly used for reducing the τₘₐₓ/T ratio. The delay time τₘₐₓ is influenced by the environmental factor, but not by the radio signal. Therefore, the sole method is increasing the intersymbol duration T, but the data transmission rate will be reduced at the same time. The OFDM can satisfy the requirements for high transmission rate and low ISI, wherein all data are allocated to many sub-carriers for parallel transmission instead of transmitting signals by a single frequency or carrier. All data are assumed to be allocated to N sub-carriers with different frequencies, and the transmission interval between each sub-carrier is extended to N times of a single-carrier, in such a way, although the transmission rate of each sub-carrier is 1/N of the original single-carrier, the total transmission rate of the N parallel sub-carriers holds the same. Furthermore, for each sub-carrier, the τₘₐₓ/T ratio has reduced to τₘₐₓ/NT, which means that the ISI allowance of each sub-carrier is N times of the original. Other than increasing the anti-interference capacity for the ISI, the sub-carriers parallel introduced into the OFDM may also enable the signal not to be influenced by the frequency selective fading. Assuming that a single carrier is used to transmit data, if interference exists in a channel, all signal transmissions will fail, while such a situation has a little influence on the multi-carrier system, wherein only a few sub-carriers will be influenced. Also, redundant information provided by a cyclic redundancy check (CRC) can be used to examine the incorrect data caused by the interference.

However, for the system solving the multipath effect by using the OFDM technique, the CCI still remains to be overcome. For CCI suppression in the OFDM communication system, current techniques comprise interference signal estimation and cancellation, smart antennas, and joint detection with antenna arrays. However, the above techniques have the following disadvantages respectively: the interference signal should be estimated in advance, and the maximum detection error is two times the estimation error; there is a limit in solely using a spatial processing technology in CCI suppression, and the processing complexity is directly proportional to the accuracy; joint signal detection with antenna arrays only considers how to get an optimum solution of the desired carrier, without considering the influence caused by other sub-carriers.

To provide a solution for the CCI suppression in OFDM systems by the antenna arrays, the conventional techniques, for example, U.S. Pat. Nos. 5973642, 6141393, 6711412, and 6795424, adopt a receiving apparatus containing antenna arrays, and suppress the interference of other directions by using the spatial technology of the antenna arrays, then make a decision for each sub-carrier signal. However, it is only a simple antenna array process; although the complexity is low, whether signals of other sub-carriers interfere with the desired carrier or not is not taken into consideration. Therefore, it is still necessary to provide a new method for suppressing CCI to eliminate the above defects.

### SUMMARY OF THE INVENTION

To solve the above problems, the present invention discloses a method for co-channel interference (CCI) suppression in Orthogonal Frequency Division Multiplexing (OFDM) systems with multiple receiving antenna, thereby enhancing the anti-CCI ability of the OFDM wireless communication base station.

Therefore, to achieve the above objects, the method for CCI suppression in OFDM systems with multiple receiving antennas disclosed in the present invention adopts a receiving apparatus containing antenna arrays and carries out a joint processing by using the signals captured by the antenna arrays and the signals of other sub-carriers, wherein three signal detection algorithms are provided: linear minimum mean error (LMMSE), multistage interference cancellation (MIC), and enhancement multistage interference cancellation (EMIC). The whole interference cancellation process is completed by increasing the signal process resolution by the antenna arrays, accurately estimating signals of other sub-carriers with multistage recursion detection, subtracting the interference items caused by other sub-carriers from the desired carrier signal. In summary, the method disclosed in the present invention is used to efficiently suppress CCI in the OFDM communication system. Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1A is a flow chart of detecting signals by a linear minimum mean square error (MMSE) of the present invention;

FIG, 1B is a block diagram 10 of detecting signals by the LMMSE of the present invention;

FIG. 2A is a flow chart of detecting signals by a multistage interference cancellation (MIC) of the present invention;

FIG. 2B is a block diagram of detecting signals by the MIC of the present invention;

FIG. 3A is a flow chart of detecting signals by an enhancement multistage interference cancellation (EMIC) of the present invention;

FIG. 3B is the other flow chart of detecting signals by an EMIC of the present invention; and

FIG. 3C is a flow chart of detecting signals by the EMIC of the present invention.

### DETAILED DESCRIPTION OF THE INVENTION

The detailed features and advantages of the present invention are described in detail in the following detailed description, the text thereof enables any skilled in the art to understand the technical content of the present invention and implement accordingly, and any skilled in the art may understand the related objects and advantages of the present invention according to the disclosures, claims, and drawings of the specification.

Three embodiments of the present invention are illustrated, wherein each embodiment is implemented by an OFDM system with adaptive antenna arrays. A receiver with antenna arrays receives signals by using M antennas, the received signal of each antenna is expressed by Equation (1), and each embodiment deduces with a mathematical algorithm a desired information bit of the desired sub-carrier.

Three signal detection algorithms are used in each embodiment respectively: linear minimum mean square error (LMMSE) signal detection, multistage interference cancellation (MIC) signal detection, and enhancement multistage interference cancellation (EMIC) signal detection. By increasing the signal process resolution by the antenna arrays, accurately estimating the signals of other sub-carriers via multistage recursion detection, and then subtracting the interference item caused by other sub-carriers from the signal of the desired carrier, the whole interference cancellation process is completed, and thereby the desired information bit of the desired sub-carrier is resolved.

rₘ(t)=sₘ(t)+iₘ(t)+nₘ(t), m=1, 2, . . . , M (1)

In Equation (1), rₘ(t) represents the received signal of the mth antenna; nₘ(t) represents the white Gaussian noise with a power spectral density of N₀/2 received by the mth antenna; iₘ(t) represents a CCI interference received by the mth antenna; sₘ(t) represents the OFDM signal received by the mth antenna after a channel effect, and is expressed by Equation (2) as follows.

$${s}_{m} ( t ) = {\sum }_{p = 0}^{P - 1} {\sum }_{q = 0}^{{N}_{c} - 1} \sqrt{2 {E}_{b}} b ( p , q ) {\sum }_{k = 0}^{K - 1} {c}_{m , k} {h}_{q} ( t - {pT}_{5} - k β {T}_{5} / L ) \qquad ( 2 )$$

Equation (2) describes that the OFDM signal sₘ(t) is formed by passing multiple information bits or symbols carried through a channel having a channel effect and a multipath effect. That is, in Equation (2), P represents the number of symbols contained in an OFDM signal; N_{c} represents the number of sub-carriers contained in an OFDM signal; b(p,q) represents the uncorrelated coded information bit of the qth sub-carrier in the pth symbol; the b(p,q)ε{±1}, E_{b} represent the bit energy; K represents the number of paths the OFDM signal sₘ(t) can be decomposed into; c_{m,0},c_{m,1}, . . . , c_{m,K-1} represent the fading channel coefficients of different paths under the mth antenna, and the coefficient is a complex-valued Gaussian random variable; h_{q}(t) represents a transfer function of channel effect of the qth sub-carrier; Tₛ indicates the symbol duration; L indicates the channel length; and β indicates the sampling factor. Therefore, the received signal of the 0th symbol received by the mth antenna is expressed by Equation (3) as follows.

$${\underline{r}}_{m} = {\sum }_{q = 0}^{{N}_{c} - 1} b ( 0 , q ) {\underline{s}}_{m , q} + {\underline{i}}_{m} + {\underline{n}}_{m} \qquad ( 3 )$$

After the received signal of the 0th symbol received by all M antennas is expressed by Equation (3), a received signal vector r is generated, expressed by Equation (4).

r=[r₁^{T}r₂^{T}K r_{M}^{T}]^{T} (4)

Herein, the object of all embodiments is to calculate a desired information bit of the 0th symbol of the qth sub-carrier.

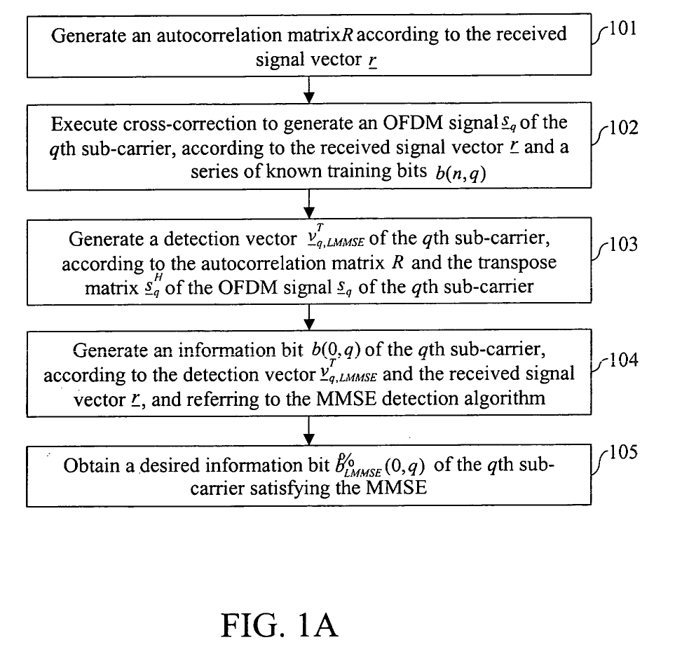

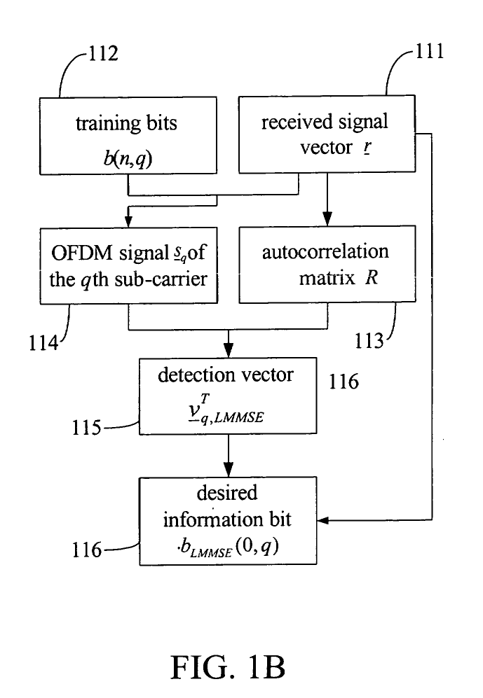

The first embodiment refers to FIG. 1A and FIG. 1B. FIG. 1A is a flow chart of detecting signals by the LMMSE and FIG. 1B is a block diagram 10 of detecting signals by the LMMSE, the embodiment comprises the following steps.

Generate an autocorrelation matrix R 113, according to the received signal vector r 111 (Step 101), expressed by Equation (5) as follows.

R=E[rr^{H}] (5)

Execute cross-correction to generate an OFDM signal s_{q} 114 of the qth sub-carrier, according to the received signal vector r 111 and a series of known training bits b(n,q) 112 (Step 102), expressed by Equation (6) as follows.

s_{q}=E[r×b(n,q)] (6)

Generate a detection vector v_{q,LMMSE}^{T} 115 of the qth sub-carrier, according to the autocorrelation matrix R 113 and the transpose matrix s_{q}^{H} of the OFDM signal s_{q} 114 of the qth sub-carrier (Step 103), expressed by Equation (7) as follows.

v_{q,LMMSE}^{T}=s_{q}^{H}R⁻¹ (7)

Generate an information bit b(0,q) of the qth sub-carrier, according to the detection vector v_{q,LMMSE}^{T} 115 and the received signal vector r 111, and referring to the MMSE detection algorithm (Step 104), the MMSE detection algorithm is expressed by the Equation (8) as follows.

E[|b(0, q)−v_{q,LMMSE} ^{T}r|²] (8)

Obtain a desired information bit b_{LMMSE}^{%}(0,q) 116 of the qth sub-carrier satisfying the MMSE (Step 105), expressed by Equation (9) as follows.

b_{LMMSE}^{%}(0, q)=v_{q,LMMSE}^{T}r (9)

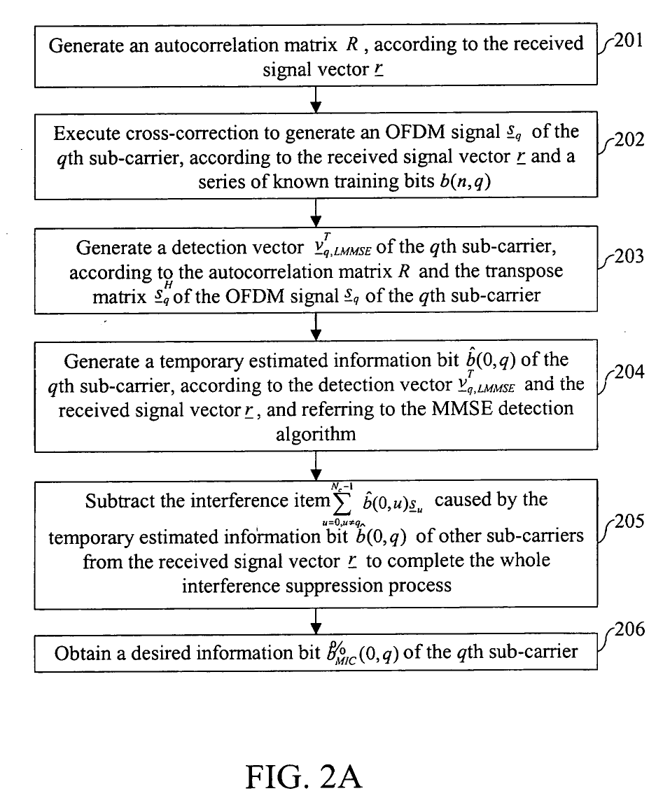

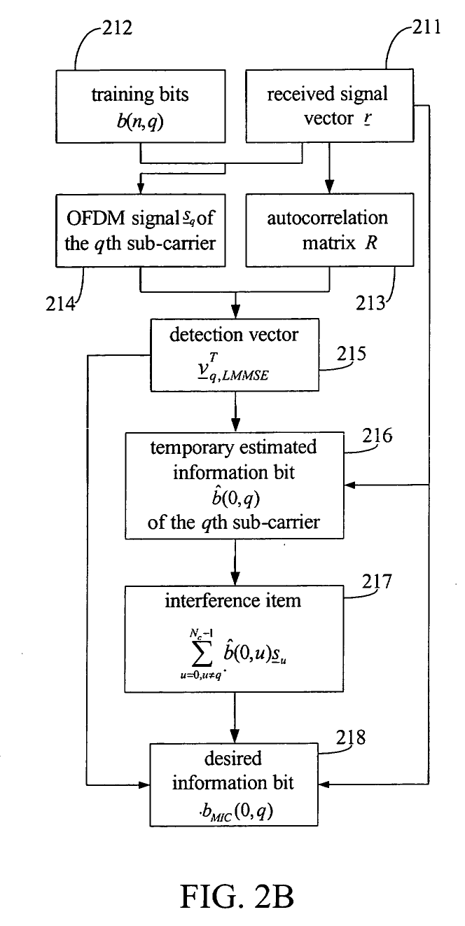

The second embodiment refers to FIG. 2A and FIG. 2B. FIG. 2A is a flow chart of detecting signals by the MIC of the present invention and FIG. 2B is a block diagram 20 of detecting signals by the MIC of the present invention, the embodiment comprises the following steps.

Generate an autocorrelation matrix R 213, according to the received signal vector r 211 (Step 201), expressed by Equation (10) as follows.

R=E[rr^{H}] (10)

Execute cross-correction to generate an OFDM signal s_{q} 214 of the qth sub-carrier, according to the received signal vector r 211 and a series of known training bits b(n,q) 212 (Step 202), expressed by Equation (11) as follows.

s_{q}=E[r×b(n,q)] (11)

Generate a detection vector v_{q,LMMSE}^{T} 215 of the qth sub-carrier, according to the autocorrelation matrix R 213 and the transpose matrix s_{q}^{H} of the OFDM signal s_{q} 214 of the qth sub-carrier (Step 203), expressed by Equation (12) as follows.

v_{q,LMMSE}^{T}=s_{q}^{H}R⁻¹ (12)

Generate a temporary estimated information bit \hat{b}(0,q) 216 of the qth sub-carrier, according to the detection vector v_{q,LMMSE}^{T} 215 and the received signal vector r 211, and referring to the MMSE detection algorithm (Step 204), expressed by the Equation (13) as follows.

\hat{b}(0,q)=v_{q,LMMSE}^{T}r (13)

Subtract the interference item

$${\sum }_{u = 0 , u \neq q}^{{N}_{c} - 1} \hat{b} ( 0 , u ) {\underline{s}}_{u}$$

217 caused by the temporary estimated information bit \hat{b}(0, q) 216 of other sub-carriers from the received signal vector r 211 to complete the whole interference suppression process (Step 205), therefore, Obtain a desired information bit b_{MIC}^{%}(0,q) 218 of the qth sub-carrier (Step 206), expressed by Equation (14) as follows.

$${b}_{MIC}^{\%} ( 0 , q ) = {\underline{v}}_{q , LMMSE}^{T} [ \underline{r} - {\sum }_{u = 0 , u \neq q}^{{N}_{c} - 1} \hat{b} ( 0 , u ) {\underline{s}}_{u} ] \qquad ( 14 )$$

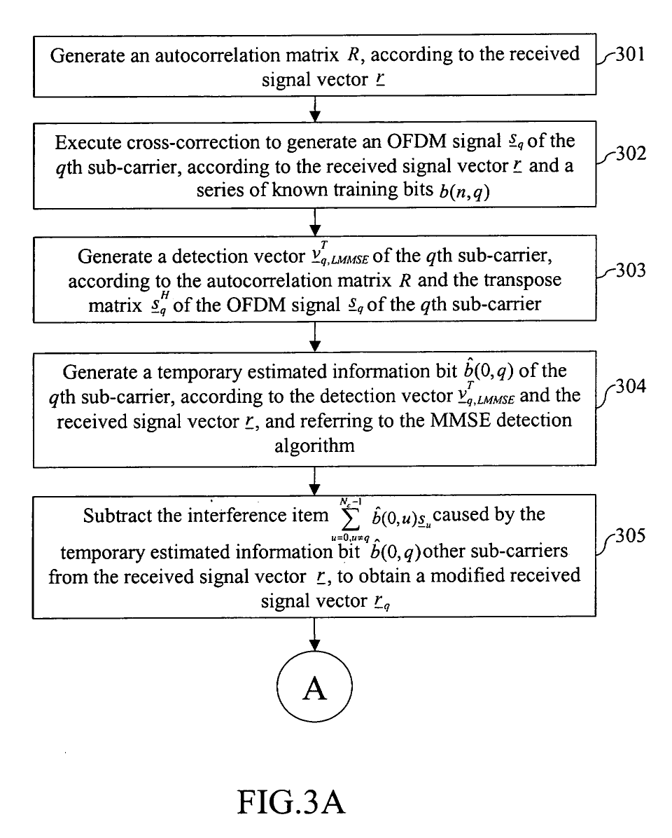

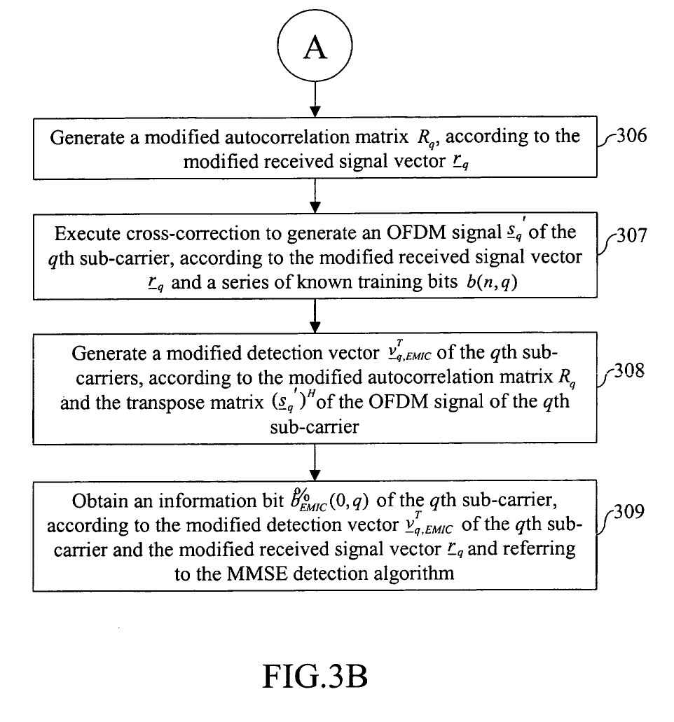

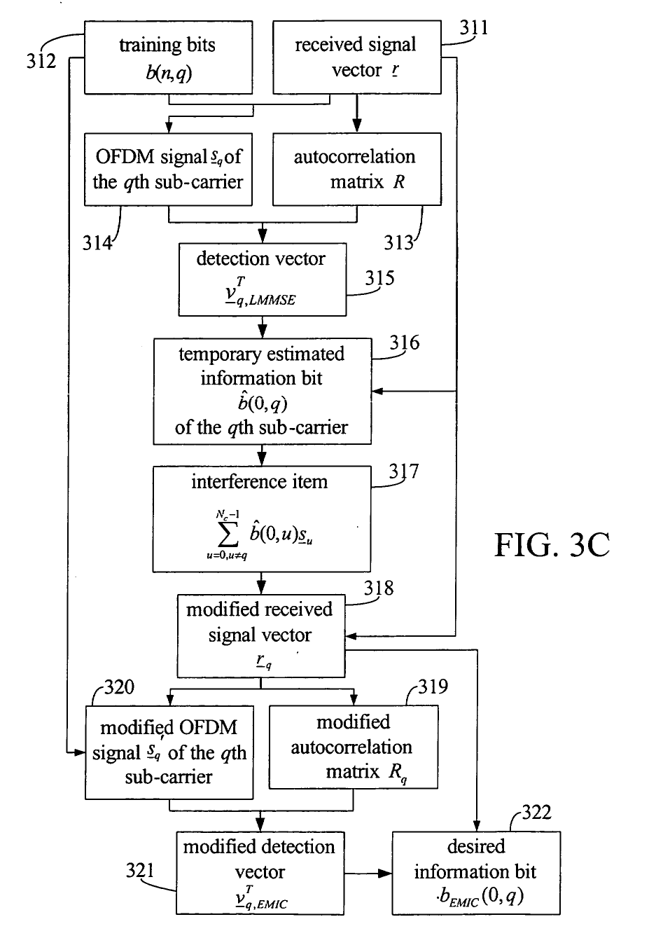

The third embodiment refers to FIGS. 3A, 3B, and 3C. FIGS. 3A and 3B are flow charts of detecting signals by the EMIC of the present invention and FIG. 3C is a block diagram 30 of detecting signals by the EMIC of the present invention, the embodiment modifying the second embodiment and comprises the following steps.

Generate an autocorrelation matrix R 313 (Step 301), according to the received signal vector r 311, expressed by Equation (15) as follows.

R=E[rr^{H}] (15)

Execute cross-correction to generate an OFDM signal s_{q} 314 of the qth sub-carrier, according to the received signal vector r 311 and a series of known training bits b(n, q) 312 (Step 302), expressed by Equation (16) as follows.

s_{q}=E[r×b(n, q)] (16)

Generate a detection vector v_{q,LMMSE}^{T} 315 of the qth sub-carrier, according to the autocorrelation matrix R 313 and the transpose matrix s_{q}^{H} of the OFDM signal s_{q} 314 of the qth sub-carrier (Step 303), expressed by Equation (17) as follows.

v_{q,LMMSE}^{T}=s_{q}^{H}R⁻¹ (17)

Generate a temporary estimated information bit 316 of the qth sub-carrier, according to the detection vector v_{q,LMMSE}^{T} 315 and the received signal vector r 311, and referring to the MMSE detection algorithm (Step 304), expressed by the Equation (18) as follows.

\hat{b}(0,q)=v_{q,LMMSE}^{T}r (18)

Subtract the interference item

$${\sum }_{u = 0 , u \neq q}^{{N}_{c} - 1} \hat{b} ( 0 , u ) {\underline{s}}_{u}$$

317 caused by the temporary estimated information bit \hat{b}(0,q) 316 other sub-carriers from the received signal vector r 311, to obtain a modified received signal vector r_{q} (step 305), expressed by Equation (19) as follows. Referring to FIG. 3B, the subsequent steps continued by a procedure A as shown in the drawing.

$${\underline{r}}_{q} = \underline{r} - {\sum }_{u = 0 , u \neq q}^{{N}_{c} - 1} \hat{b} ( 0 , u ) {\underline{s}}_{u} \qquad ( 19 )$$

Generate a modified autocorrelation matrix R_{q} 319, according to the modified received signal vector r_{q} 318 (Step 306), expressed by Equation (20) as follows.

R_{q}=E[r_{q}r_{q}^{H}] (20)

Execute cross-correction to generate an OFDM signal s_{q}′ 320 of the qth sub-carrier, according to the modified received signal vector r_{q} 318 and a series of known training bits b(n,q) 312 (Step 307), expressed by Equation (21) as follows.

s_{q}′=E[r_{q}×b(n,q)] (21)

Generate a modified detection vector v_{q,EMIC}^{T}′ 321 of the qth sub-carriers, according to the modified autocorrelation matrix R_{q} 319 and the transpose matrix (s_{q}′)^{H} of the OFDM signal of the qth sub-carrier (step 308), expressed by Equation (22) as follows.

v_{q,EMIC}^{T}=(s_{q}′)^{H}R_{q}⁻¹ (22)

Obtain an information bit b_{EMIC}^{%}(0,q) 322 of the qth sub-carrier, according to the modified detection vector v_{q,EMIC}^{T} 321 of the qth sub-carrier and the modified received signal vector r_{q} 318 and referring to the MMSE detection algorithm (Step 309), expressed by Equation (23) as follows.

b_{EMIC}^{%}(0,q)=v_{q}^{T}r_{q} (23)

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for co-channel interference suppression in Orthogonal Frequency Division Multiplexing (OFDM) systems with multiple receiving antennas, used in a receiver with a plurality of antennas, the methods comprises:
capturing a plurality of received signals rₘ(t) through each antenna;
capturing a plurality of training bits b(n, q) of the qth sub-carrier through each antenna;
generating a received signal vector r according to each received signal rₘ(t);
generating an autocorrelation matrix R according to the received signal vector r;
generating a signal s_{q} of the qth sub-carrier according to the received signal vector r and a plurality of training bits b(n,q) of the qth sub-carrier;
generating a detection vector v_{q,LMMSE}^{T} of the qth sub-carrier according to the autocorrelation matrix R and the transpose matrix s_{q}^{H} of the signal s_{q} of the qth sub-carrier; and
generating a desired information bit b_{LMMSE}^{%}(0,q) of the qth sub-carrier according to the detection vector v_{q,LMMSE}^{T} of the qth sub-carrier and the received signal vector r.

2. The method for co-channel interference suppression in OFDM systems with multiple receiving antennas as claimed in claim 1, wherein the received signal vector r is generated according to a first equation:
r=[r₁^{T}r₂ ^{T}K r_{M}^{T}]^{T}
wherein, r₁^{T} represents a first received signal of each received signal; r₂^{T} represents a second received signal of each received signal; r_{M}^{T} represents an Mth received signal of each received signal, and M represents the number the antennas.

3. The method for co-channel interference suppression in OFDM systems with multiple receiving antennas as claimed in claim 1, wherein the autocorrelation matrix R is generated according to a second equation:
R=E[rr^{H}]

4. The method for co-channel interference suppression in OFDM systems with multiple receiving antennas as claimed in claim 1, wherein the signal s_{q} of the qth sub-carrier is generated according to a third a third equation:
s_{q}=E[r×b(n,q)]
wherein the received signal vector r and the plurality of the plurality of training bits b(n, q) of the qth sub-carrier is used for cross-correction.

5. The method for co-channel interference suppression in OFDM systems with multiple receiving antennas as claimed in claim 1, wherein the detection vector v_{q,LMMSE}^{T} of the qth sub-carrier is generated according to a fourth equation:
v_{q,LMMSE}^{T}=s_{q}^{H}R⁻¹

6. The method for co-channel interference suppression in OFDM systems with multiple receiving antennas as claimed in claim 1, wherein the desired information bit b_{LMMSE}^{%}(0,q) of the qth sub-carrier is generated according to a fifth equation:
b_{LMMSE}^{%}(0,q)=v_{q,LMMSE}^{T}r

7. The method for co-channel interference suppression in OFDM systems with multiple receiving antennas as claimed in claim 6, wherein the fifth equation is in accordance with a minimum mean square error (MMSE) equation:
E [|b(0,q)−v_{q,LMMSE}^{T}r|²]
wherein, b(0,q) represents an information bit of a qth sub-carrier.

8. A method for co-channel interference suppression in OFDM systems with multiple receiving antennas, used in a receiver with a plurality of antennas, the method comprises:
capturing a plurality of received signals rₘ(t) through each antenna;
capturing a plurality of training bits b(n,q) of the qth sub-carrier through each antenna;
generating a received signal vector r according to each received signal rₘ(t);
generating an autocorrelation matrix R according to the received signal vector r;
generating a signal s_{q} of the qth sub-carrier according to the received signal vector r and a plurality of training bits b(n,q) of the qth sub-carrier;
generating a detection vector v_{q,LMMSE}^{T} of the qth sub-carrier according to the autocorrelation matrix R and the transpose matrix s_{q}^{H} of the signal s_{q} of the qth sub-carrier;
generating a desired information bit b_{LMMSE}^{%}(0,q) of the qth sub-carrier according to the detection vector v_{q,LMMSE}^{T} of the qth sub-carrier and the received signal vector r;
performing an interference suppression process, according to the received signal vector r and the temporary information bit \hat{b}(0,q); and
generating a desired information bit b_{MIC}^{%}(0,q) of the qth sub-carrier according to the detection vector v_{q,LMMSE}^{T} of the qth sub-carrier, the received signal vector r, and the temporary information bit \hat{b}(0,q);
wherein the interference suppression process is performed by subtract the interference item
$${\sum }_{u = 0 , u \neq q}^{{N}_{c} - 1} \hat{b} ( 0 , u ) {\underline{s}}_{u}$$
caused by the temporary estimated information bit \hat{b}(0,q) of the sub-carriers from the received signal vector r.

9. The method for co-channel interference suppression in OFDM systems with multiple receiving antennas as claimed in claim 8, wherein the received signal vector r is generated according to a first equation:
r=[r₁^{T}r₂^{T}K r_{M}^{T}]^{T}
wherein, rᵢ^{T} represents a first received signal of each received signal; r₂^{T} represents a second received signal of each received signal; r_{M}^{T} represents an Mth received signal of each received signal, and M represents the number of the antennas.

10. The method for co-channel interference suppression in OFDM systems with multiple receiving antennas as claimed in claim 8, wherein the autocorrelation matrix R is generated according to a second equation:
R=E[rr^{H}]

11. The method for co-channel interference suppression in OFDM systems with multiple receiving antennas as claimed in claim 8, wherein the signal s_{q} of the qth sub-carrier is generated according to a third a third equation:
s_{q}=E[r×b(n,q)]
wherein the received signal vector r and the plurality of the plurality of training bits b(n,q) of the qth sub-carrier is used for cross-correction.

12. The method for co-channel interference suppression in OFDM systems with multiple receiving antennas as claimed in claim 8, wherein the detection vector v_{q,LMMSE}^{T} of the qth sub-carrier is generated according to a fourth equation:
v_{q,LMMSE}^{T}=s_{q}^{H}R⁻¹

13. The method for co-channel interference suppression in OFDM systems with multiple receiving antennas as claimed in claim 8, wherein the temporary information bit \hat{b}(0,q) is generated according to a fifth equation:
\hat{b}(0,q)=v_{q,LMMSE}^{T}r

14. The method for co-channel interference suppression in OFDM systems with multiple receiving antennas as claimed in claim 8, wherein the interference suppression process is performed in accordance with a sixth equation:
$$\underline{r} - {\sum }_{u = 0 , u \neq q}^{{N}_{c} - 1} \hat{b} ( 0 , u ) {\underline{s}}_{u}$$

15. The method for co-channel interference suppression in OFDM systems with multiple receiving antennas as claimed in claim 8, wherein the desired information bit b_{MIC}^{%}(0,q) of the qth sub-carrier is generated according to a seventh equation:
$${b}_{MIC}^{\%} ( 0 , q ) = {\underline{v}}_{q , LMMSE}^{T} [ \underline{r} - {\sum }_{u = 0 , u \neq q}^{{N}_{c} - 1} \hat{b} ( 0 , u ) {\underline{s}}_{u} ]$$

16. The method for co-channel interference suppression in OFDM systems with multiple receiving antennas as claimed in claim 13, wherein the fifth equation is in accordance with a minimum mean square error (MMSE) equation:
E[|b(0,q)−v_{q,LMMSE}^{T}r|²]
wherein, b(0,q) indicates an information bit of a qth sub-carrier.

17. The method for co-channel interference suppression in OFDM systems with multiple receiving antennas as claimed in claim 14, wherein the interference suppression process is a multistage interference cancellation.

18. The method for co-channel interference suppression in OFDM systems with multiple receiving antennas as claimed in claim 15, wherein the generation of the desired information bit b_{MIC}^{%}(0,q) of the qth sub-carrier is a signal detection of a multistage interference cancellation.

19. A method for co-channel interference suppression in OFDM systems with multiple receiving antennas, used in a receiver with a plurality of antennas, the method comprises:
capturing a plurality of received signals through each antenna rₘ(t);
capturing a plurality of training bits b(n,q) of the qth sub-carrier through each antenna;
generating a received signal vector r according to each received signal rₘ(t);
generating an autocorrelation matrix R according to the received signal vector r;
generating a signal s_{q} of the qth sub-carrier according to the received signal vector r and a plurality of training bits b(n,q) of the qth sub-carrier;
generating a detection vector v_{q,LMMSE}^{T} of the qth sub-carrier according to the autocorrelation matrix R and the transpose matrix s_{q} of the signal s_{q} of the qth sub-carrier;
generate a temporary information bit \hat{b}(0,q) according to the detection vector v_{q,LMMSE}^{T} and the received signal vector r;
generating a modified received signal vector r_{q} according to the received signal vector r and the temporary information bit \hat{b}(0,q) is performing an interference suppression process;
generating a modified signal s_{q}′ of the qth sub-carrier according to the modified received signal vector r_{q} and the plurality of training bits b(n,q) of the qth sub-carrier;
generating a modified detection vector v_{q,EMIC}^{T} according to the modified autocorrelation matrix R_{q} and the transpose matrix (s_{q}′)^{H} of the signal s_{q}^{H} of the qth sub-carrier; and
generating a desired information bit b_{EMIC}^{%}(0,q) of the qth sub-carrier according to the modified detection vector v_{q,EMIC}^{T}, the modified received signal vector r_{q};
wherein the interference suppression process is performed by subtract the interference item
$${\sum }_{u = 0 , u \neq q}^{{N}_{c} - 1} \hat{b} ( 0 , u ) {\underline{s}}_{u}$$
caused by the temporary estimated information bit \hat{b}(0,q) of the sub-carriers from the received signal vector r.

20. The method for co-channel interference suppression in OFDM systems with multiple receiving antennas as claimed in claim 19, wherein the received signal vector r is generated according to a first equation:
r=[r₁^{T}r₂^{T}Kr_{M}^{T}]^{T}
wherein, r₁^{T} represents a first received signal of each received signal; r₂^{T} represents a second received signal of each received signal; r_{M}^{T} represents an Mth received signal of each received signal, wherein M represents the number of the antennas.

21. The method for co-channel interference suppression in OFDM systems with multiple receiving antennas as claimed in claim 19, wherein the autocorrelation matrix R is generated according to a second equation:
R=E[rr^{H}]

22. The method for co-channel interference suppression in OFDM systems with multiple receiving antennas as claimed in claim 19, wherein the signal s_{q} of the qth sub-carrier is generated according to a third a third equation:
s_{q}=E[r×b(n,q)]
wherein the received signal vector r and the plurality of the plurality of training bits b(n,q) of the qth sub-carrier is used for cross-correction.

23. The method for co-channel interference suppression in OFDM systems with multiple receiving antennas as claimed in claim 19, wherein the detection vector v_{q,LMMSE}^{T} is generated according to a fourth equation:
v_{q,LMMSE}^{T}=s_{q}^{H}R⁻¹

24. The method for co-channel interference suppression in OFDM systems with multiple receiving antennas as claimed in claim 19, wherein the temporary information bit \hat{b}(0,q) is generated according to a fifth equation:
\hat{b}(0,q)=v_{q,LMMSE}^{T}r

25. The method for co-channel interference suppression in OFDM systems with multiple receiving antennas as claimed in claim 19, wherein the modified received signal vector r_{q} is generated according to a sixth equation:
$${\underline{r}}_{q} = \underline{r} - {\sum }_{u = 0 , u \neq q}^{{N}_{c} - 1} \hat{b} ( 0 , u ) {\underline{s}}_{u}$$

26. The method for co-channel interference suppression in OFDM systems with multiple receiving antennas as claimed in claim 19, wherein the modified autocorrelation matrix R_{q} is generated according to a seventh equation:
R_{q}=E[r_{q}r_{q}^{H}]

27. The method for co-channel interference suppression in OFDM systems with multiple receiving antennas as claimed in claim 19, wherein the modified signal s_{q}′ of the qth sub-carrier is generated according to an eighth equation:
s_{q}′=E[r_{q}×b(n,q)]
wherein the received signal vector r and the plurality of the plurality of training bits b(n,q) of the qth sub-carrier is used for cross-correction.

28. The method for co-channel interference suppression in OFDM systems with multiple receiving antennas as claimed in claim 19, wherein the modified detection vector v_{q,EMIC}^{T} is generated according to a ninth equation:
v_{q,EMIC}^{T}=s_{q}^{H}R_{q}⁻¹

29. The method for co-channel interference suppression in OFDM systems with multiple receiving antennas as claimed in claim 19, wherein the desired information bit b_{EMIC}^{%}(0,q) of the qth sub-carrier is generated according to an eighth equation:
b_{EMIC}^{%}(0,q)=v_{q,EMIC}^{T}r_{q}

30. The method for co-channel interference suppression in OFDM systems with multiple receiving antennas as claimed in claim 19, wherein the interference suppression process is a multistage interference cancellation.

31. The method for co-channel interference suppression in OFDM systems with multiple receiving antennas as claimed in claim 28, wherein the generation of the desired information bit b_{EMIC}^{%}(0,q) of the qth sub-carrier is a signal detection of a multistage interference cancellation.
